(19) United States
(12) Patent Application Publication
(10) Pub. No.: US 2008/0211264 A1
(43) Pub. Date: Sep. 4, 2008

(54) Reinforcement Plate For A B Column Of A Vehicle Body

(75) Inventors: Mark Riess, Fahrenzhausen (DE); Andreas Hauger, Attendorn (DE); Ludger Gehringhoff, Paderborn (DE); Johannes Schaefers, Borchen (DE)

Correspondence Address: CROWELL & MORING LLP;INTELLECTUAL PROPERTY GROUP, P.O. BOX 14300, WASHINGTON, DC, 20044-4300, US

(73) Assignees: Bayerische Motoren Werke Aktiengesellschaft, Muenchen (DE); Muhr und Bender KG, Attendorn (DE); Benteler Automobiltechnik GmbH, Paderborn (DE)

(21) Appl. No.: 12/029,796

(22) Filed: Feb. 12, 2008

Related U.S. Application Data
(63) Continuation of application No. PCT/EP2006/007769, filed on Aug. 5, 2006.

(30) Foreign Application Priority Data
Aug. 13, 2005 (DE) 10 2005 038 488.9

(51) Int. Cl. B60R 27/00; B21B 37/00

(52) U.S. Cl. 296/193.01; 72/6.2

(57) ABSTRACT

A B column of a motor vehicle having a high strength and rigidity in the attachment area of door hinges and door locks and able to protect the occupants of the vehicle in the event of a side crash is provided. The B column includes a reinforcement plate, which extends over the entire height of the B column. Because the requirements for this reinforcement plate are not equally great in all areas, the reinforcement plate is a reshaped tailored rolled blank. The tailored rolled blank is produced by flexible rolling and has different thicknesses transversely to the rolling direction. It is thus especially thick in the areas on which especially high strength and rigidity requirements are placed, while it is implemented as correspondingly thin in the areas which must only fulfill low strength and rigidity requirements.

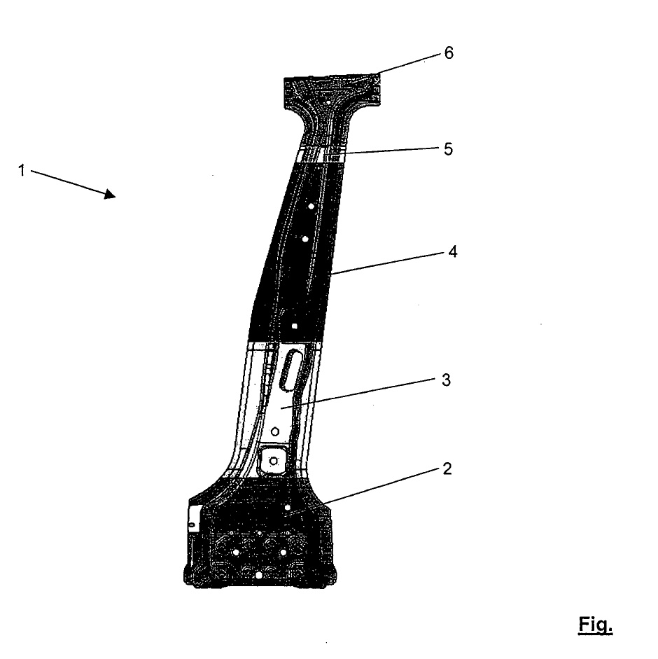

### CROSS-REFERENCE TO RELATED APPLICATIONS

This application is a continuation of PCT International Application No. PCT/EP2006/007769, filed on Aug. 5, 2006, which claims priority under 35 U.S.C. § 119 to German Application No. 10 2005 038 488.9, filed Aug. 13, 2005, the entire disclosures of which are expressly incorporated by reference herein.

### BACKGROUND AND SUMMARY OF THE INVENTION

The present invention relates to a reinforcement plate for a B column of a vehicle body.

The use of so-called tailored welded blanks in automobile construction is already generally known. Thus, for example, it is stated in the book “Tailored Blanks,” Vol. 250 of the series “Die Bibliothek der Technik [The Library of Technology],” Verlag moderne industrie (ISBN 3-478-93294-7) on page 10 et seq.: “A vehicle comprises manifold individual parts, which are assembled into subgroups. Such a subgroup must typically fulfill various requirements which are partially contradictory, however. Thus, for example, a door is to have the lowest possible weight, i.e., to comprise the thinnest possible sheet metal, and nonetheless have great strength and rigidity in the area of the hinges. To fulfill these contradictory requirements, the properties of the various door areas are typically optimized by integrating additional individual parts. In the area of the door hinges and the lock, reinforcements must be welded to the door internal plate to ensure the required strength for absorbing the forces engaging there. The integration of additional individual parts causes costs, because these parts must be produced and connected to the subgroup separately. In addition, individual features of the subgroup may be worsened by the joining methods used. Additional fusion and spot welds increase the thermally caused distortion, for example, and thus increase the deviations from the desired shape of the subgroup.

A tailored blank comprises multiple plates of differing thickness, mechanical properties, and surface coatings. The location-dependent properties may already be implemented via the material properties of the plates. Therefore, no additional components are to be manufactured for reinforcement, for example. The smaller number of individual parts also results in a reduction of component tolerances of the subgroup. Tailored blanks frequently reduce the weight of the subgroup. For applications such as the vehicle floor, spot weld bonds on overlapping plate edges may be replaced by continuous laser-welded seams. Because the overlapping of the plates is dispensed with, the material usage is reduced and weight is saved.”

The object of the present invention is to provide a reinforcement plate for a B column of a vehicle body, which fulfills the requirements in all partial areas, so that no additional individual components are required to reinforce the B column besides the reinforcement plate.

This object is achieved by a reinforcement plate for a B column of a vehicle body which extends over the entire height of the B column, and which includes a reshaped tailored rolled blank.

A “B” column of a vehicle body typically includes at least an external shell, which is typically implemented in one piece with a lateral frame, which also forms at least a part of a lateral sill board, a roof lateral frame, an A column, and possibly a C column. The external shell, and thus possibly the lateral frame, are to comprise the thinnest possible sheet metal for reasons of weight. On the other hand, the B column must have a high strength in the attachment area of door hinges and door locks and for protecting the occupants of the vehicle in the event of a side crash. For this purpose, the B column has a reinforcement plate, which extends over the entire height of the B column. The requirements on this reinforcement plate are not equally great in all areas. Thus, the reinforcement plate must only fulfill relatively low strength and rigidity requirements in the lower section, in which the B column adjoins the lateral sill board, while the requirements for the reinforcement plate are significantly higher in the upper half to ensure that in the event of a side crash, the B column deforms as little as possible into the passenger compartment.

According to the present invention, the reinforcement plate includes a reshaped tailored rolled blank. A tailored rolled blank is produced by flexible rolling. It has various thicknesses transversely to the rolling direction. The areas of different thickness run parallel to one another. The material properties of the component may only be influenced in a very restricted way because of the method.

In contrast to a classic tailored welded blank, as described in the book specified above, the tailored rolled blank thus does not comprise different materials, but rather only has different thicknesses transverse to the rolling direction.

The reinforcement plate according to the present invention, which is produced from such a tailored rolled blank, may accordingly have different plate thicknesses at different heights of the B column. It may thus be especially thick in the areas on which especially high strength and rigidity requirements are placed, while it may be implemented as accordingly thin in the areas which must only fulfill low strength and rigidity requirements. Thus, using a single reinforcement plate, the different requirements in the individual areas may be fulfilled. On the other hand, the reinforcement plate is not so thick everywhere as it is in the area having the highest requirements. The reinforcement plate according to the present invention thus has a significantly lower weight than a reinforcement plate which is reshaped from a conventional sheet metal plate.

In addition, the tailored rolled blank may have arbitrarily many areas with different thicknesses, without the production costs being increased in this way, as with a tailored welded blank. It may thus be tailored optimally to the particular use without the increasing production costs.

Advantageously, the tailored rolled blank, preferably, includes an ultrahigh-strength steel. Ultrahigh-strength steels have a yield strength of approximately 420 N/mm² or more. Ideally, the ultrahigh-strength steel has a yield strength of 1300 N/mm². Such a steel is commercially available under the name BTR 165, for example. Ultrahigh-strength steel plates of this type already have very high strength at relatively thin plate thicknesses, so that they have a significantly lower weight at the same strength in comparison to conventional steel plates. The reinforcement plate, which is reshaped from the tailored rolled blank made of an ultrahigh-strength steel, has a correspondingly low weight. Upon the selection of the suitable plate quality, however, it must be ensured that the required degree of reshaping may be achieved reliably during deep drawing, without the steel plate tearing.

The reinforcement plate advantageously includes a hot-reshaped tailored rolled blank. During hot reshaping, there is insignificantly little or no strain hardening in the steel plate, because it is reshaped at temperatures above the recrystallization temperature of the steel plate, which are significantly above the normal room temperature. Steel qualities having a tensile strength which would not have the degree of reshaping required for the reinforcement plate in the event of cold reshaping may thus be used. The same strength may thus be achieved using lower plate thicknesses as with a blank having greater plate thicknesses which is cold-reshaped. The weight of the reinforcement plate may thus be reduced. The resilience effects are thus also significantly less with a hot reshaping method than with a cold reshaping method, so that the reinforcement plate has lower tolerances than a comparable reinforcement plate produced in a cold reshaping method.

Other objects, advantages and novel features of the present invention will become apparent from the following detailed description of the invention when considered in conjunction with the accompanying drawing.

### BRIEF DESCRIPTION OF THE DRAWING

The single FIGURE shows a schematic illustration of a side view of a reinforcement plate of a B column of a body of a passenger automobile.

### DETAILED DESCRIPTION OF THE DRAWING

Referring to the single FIGURE, a reinforcement plate 1 of a B column of a vehicle body of a sedan is shown, which extends over the entire height of the B column. The B column is provided with a shell construction made from an internal shell and an external shell. The external shell is implemented in one piece with a lateral frame, which also forms an external shell for an A column, a lateral sill board, and a roof lateral frame, as well as a rear fender. This lateral frame, which also forms the external shell of the B column, is made of a relatively thin plate having a plate thickness of approximately 0.8 mm. The B column thus does not have sufficient strength and rigidity in the area of door hinges and in the area of a door lock. The strength of the B column is also insufficient for avoiding significant deformation of the B column in the event of a side crash. To increase the strength and the rigidity of the B column, the reinforcement plate 1 is situated between the internal shell and the external shell of the B column.

The reinforcement plate 1 is a hot-reshaped tailored rolled blank made of an ultrahigh-strength steel having a yield strength of 1300 N/mm². Due to the production of the reinforcement plate 1 from a tailored rolled blank, it may have different sheet thicknesses at different heights of the B column.

The requirements for the strength and rigidity of the B column are especially great in the upper half, because the adjoining side doors only still contribute slightly to the strength and rigidity of the body above the door shoulder line. The reinforcement plate 1 therefore has an especially high plate thickness of 2.2 mm in the upper area 4. The upper boundary area 6, which adjoins a roof lateral frame, and the lower boundary area 2, which adjoins a lateral sill board, in contrast, only must have a low strength and rigidity. Therefore, the two boundary areas 2 and 6 only have a plate thickness of 1.2 mm. The lower area 3 between the upper area 4 and the lower boundary area 2 also has to fulfill only relatively low requirements, so that a plate thickness of 1.4 mm is sufficient in the lower area 3. Because of the great differences in the plate thickness between upper area 4 and the upper boundary area 6, a small transition area 5 having a plate thickness of 1.6 mm is located between these areas. The different plate thicknesses between the individual areas 2, 3, 4, 5, and 6 each pass continuously and without thickness jumps into one another. A transition area of at least 20 mm in the height direction of the B column is required per difference in the plate thickness of 0.1 mm. Due to the design of the plate thickness of the reinforcement plate 1 in the individual areas 2, 3, 4, 5, and 6 in accordance with the particular requirement, the reinforcement plate 1 is not thicker than necessary in any area 2, 3, 4, 5, and 6. The reinforcement plate 1 thus has a significantly lower weight than a conventional reinforcement plate made of a blank having a uniform plate thickness.

In addition, the reinforcement plate 1 is made of an ultrahigh-strength steel. A steel plate of this type already has a strength at plate thicknesses which are significantly less than the plate thicknesses of a steel plate having the same strength made of a non-ultrahigh-strength type of steel. However, such an ultrahigh-strength steel will tear already upon cold reshaping at comparatively small degrees of reshaping. Therefore, the reinforcement plate 1 is hot reshaped. During hot reshaping, there is insignificantly little or no strain hardening in the steel plate, because it is reshaped at temperatures above the recrystallization temperature of the steel plate, which are significantly above normal room temperature. Therefore, in spite of the use of ultrahigh-strength types of steel, the required degrees of reshaping may be implemented without the tailored rolled blank thus tearing.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A component for a B column of a vehicle body, comprising:
a reinforcement plate extending over an entire height of the B column of the vehicle body; and
wherein the reinforcement plate is a reshaped tailored rolled blank.

2. The component according to claim 1, wherein the reshaped tailored rolled blank is made of an ultrahigh-strength steel.

3. The component according to claim 2, wherein the ultrahigh-strength steel has a yield strength of 1300 N/mm² or more.

4. The component according to claim 1, wherein the reshaped tailored rolled blank is a hot-reshaped tailored rolled blank.

5. The component according to claim 2, wherein the reshaped tailored rolled blank is a hot-reshaped tailored rolled blank.

6. The component according to claim 3, wherein the reshaped tailored rolled blank is a hot-reshaped tailored rolled blank.

7. The component according to claim 1, wherein the tailored rolled blank comprises a plurality of areas having different thicknesses, transitions between the plurality of areas being continuous and without discrete steps in thickness.

8. The component according to claim 2, wherein the tailored rolled blank comprises a plurality of areas having different thicknesses, transitions between the plurality of areas being continuous and without discrete steps in thickness.

9. The component according to claim 3, wherein the tailored rolled blank comprises a plurality of areas having different thicknesses, transitions between the plurality of areas being continuous and without discrete steps in thickness.

10. The component according to claim 4, wherein the tailored rolled blank comprises a plurality of areas having different thicknesses, transitions between the plurality of areas being continuous and without discrete steps in thickness.

11. A vehicle body, comprising:
a B column of the vehicle body, the B column having a defined height; and
a reinforcement plate operatively configured for the B column, the reinforcement plate extending over the defined height of the B column; and
wherein the reinforcement plate is formed of a reshaped tailored rolled blank.

12. The vehicle body according to claim 11, wherein the tailored rolled blank comprises an ultrahigh-strength steel.

13. The vehicle body according to claim 12, wherein the ultrahigh-strength steel has a yield strength of 1300 N/mm² or more.

14. The vehicle body according to claim 13, wherein the reshaped tailored rolled blank is hot-reshaped.

15. The vehicle body according to claim 11, wherein the reinforcement plate includes a plurality of areas having different thicknesses, and further wherein transitions between the plurality of areas are continuous.

16. A method of forming a reinforcement plate for a B column of a vehicle body, the method comprising the acts of:
providing a tailored rolled blank for the B column of the vehicle body;
reshaping the tailored rolled blank via flexible rolling to provide areas of different thickness, the areas of different thickness being transverse to a rolling direction and extending in parallel to one another.

17. The method according to claim 16, wherein the act of reshaping is performed by hot-reshaping of the tailored rolled blank comprising an ultrahigh-strength steel.
